(19) United States
(12) Patent Application Publication
(10) Pub. No.: US 2006/0030645 A1
(43) Pub. Date: Feb. 9, 2006

(54) Mattress side panels incorporating foam of enhanced flammability resistance

(76) Inventors: George Hairston, Spartanburg, SC (US); John Burns, Simpsonville, SC (US); Warren Stidham, Cohutta, GA (US); Kim Van Voorhis, Rutherfordton, NC (US)

Correspondence Address: James M. Robertson;J.M. Robertson IP Services, LLC, 233 S. Pine Street, Spartanburg, SC, 29302, US

(21) Appl. No.: 11/040,381

(22) Filed: Jan. 21, 2005

Related U.S. Application Data
(63) Continuation-in-part of application No. 10/912,868, filed on Aug. 6, 2004.

(51) Int. Cl. C08K 5/34; C08K 5/05

(52) U.S. Cl. 524/100; 524/387

(57) ABSTRACT

A mattress including a side panel structure incorporating a foam layer treated with intumescent flame retardant composition to provide substantially improved flame resistance. The foam layer is free from brominated compounds and retains pliability.

### CROSS-REFERENCE TO RELATED APPLICATIONS

This application is a continuation-in-part of prior copending application Ser. No. 10/912,868 filed 6 Aug. 2004 the contents of which are incorporated herein by reference in their entirety.

### TECHNICAL FIELD

This invention relates generally to residential and commercial mattresses and more particularly to mattress side panels that incorporate foam materials imparting enhanced resistance to flammability.

### BACKGROUND OF THE INVENTION

In a number of environments it is desirable for foam components to have a degree of flame resistance. One environment of foam use where flame resistance is desirable is in side panels for residential or commercial mattresses.

In the past, flame resistance has typically been achieved by use of synthetic flame retardant refractory fiber constituents such as asbestos, metal oxides and the like and/or by application of chemical flame resisting saturating chemical agents. While such practices have permitted the production of products having a relatively high degree of flame resistance, the practices have been relatively complex and costly to carry out. Moreover, such flame resistant fiber materials and chemical treatments may cause undesirable reactions in some users.

Intumescent compositions that react on contact to flame by charring and swelling, are known. When such compositions are subjected to flame, charring and swelling occurs forming layers which may be filled with non-flammable gasses created during the intumescent reaction. The layers so formed thus provide a degree of insulation against continued combustion. Typical applications for such intumescent compositions have included building materials and paints to prevent the spread of fire and structural damage.

It has also been proposed to use intumescent coatings across substrates such as fabrics to provide a degree of thermal protection to the substrates. By way of example only, such uses are described in U.S. Patent application US 2003/0082972 A1 in the name of Monfalcone III et. al. the contents of which are hereby incorporated by reference as if fully set forth herein. As best understood, the flame retardant compositions, which have been utilized in the past have been standard commercial intumescent compositions. While such compositions may provide enhanced levels of flame resistance, such traditional compositions may in some instances, also provide enhanced levels of stiffness to the fabric or other substrate.

Testing procedures which are believed to be appropriate for evaluating the flame resistance of a residential or commercial mattress are set forth in California Bureau of Home Furnishings and Thermal Insulation Technical Bulletin 603 (hereinafter “Technical Bulletin 603”), the contents of which will be well known to those of skill in the art and which are hereby incorporated by reference as if fully set forth herein. In the testing procedure of Technical Bulletin 603 a pair of propane burners are utilized to mimic the heat flux levels and durations imposed on a mattress and foundation by burning bedclothes. These burners impose differing fluxes for differing times on the mattress top and on the sides of the mattress and any underlying foundation. The resulting smoke plume is captured and heat release levels are measured by oxygen consumption calorimetry using instrumentation as set forth in ASTM E 1590 (incorporated by reference). The test method also provides a measure of the emissions of carbon monoxide and carbon dioxide.

In the test of Technical Bulletin 603, propane gas from a source such as a bottle having a net heat of combustion of 46.5±0.5 MJ/kg (nominally 99% to 100% propane) is delivered through a multi-orifice stainless steel manifold burner having 34 openings (17 on each side of a T junction with the gas inlet) arranged to impact the top of the mattress. Propane is simultaneously delivered through a similar manifold burner having 28 openings (14 on each side of a T junction with the gas inlet) arranged to impact the sides the mattress/foundation. The openings in the burners are drilled using a #56 drill and are 1.17 mm to 1.22 mm in diameter. The gas flow rate to the top burner is 12.9±0.1 L/min at a pressure of 101±5 kPa (standard atmospheric pressure) and a temperature of 22±3 degrees Celsius corresponding to a flow rate of about 0.38 L/min per opening. The gas flow rate to the side burner is 6.6±0.5 L/min at a pressure of 101±5 kPa (standard atmospheric pressure) and a temperature of 22±3 degrees Celsius corresponding to a flow rate of about 0.24 L/min per opening. The duration of gas flow is 70 seconds for the top burner and 50 seconds for the side burner. Under the testing criteria of Technical Bulletin 603, a mattress or a mattress/box spring set is considered to pass if the maximum rate of heat release is less than 150 kW and the total heat release is less than 25 MJ in the first 10 minutes of the test. Duration of the test is 30 minutes total.

### SUMMARY OF THE INVENTION

The present invention provides advantages and alternatives over the prior art by providing a side panel for a mattress including a foam constituent treated with intumescent flame retardant compositions to provide substantially improved flame resistance. The invention achieves the goal of enhanced fire retardancy without using brominated compounds such as decabromines, octabromines, pentabromines and their derivatives that may be undesirable to some users. Moreover, the present invention does not require substantial percentages of fiberglass, toxic substances, skin irritants, or other materials that may present disposal issues or which otherwise may not be environmentally friendly.

### BRIEF DESCRIPTION OF THE DRAWINGS

The following drawings which are incorporated in and which constitute a part of this specification illustrate various exemplary embodiments and practices according to the present invention and, together with the general description above and the detailed description set forth below, serve to explain the principles of the invention wherein:

FIG. 1 is a perspective view of a mattress and box spring set incorporating a textile surface side panel with an attached layer of foam;

FIG. 1A is a cross-sectional view through an exemplary mattress side panel incorporating a layer of foam; and

FIG. 2 is a simplified illustration of a processing line for applying an infused treatment of flame retardant composition to a foam substrate for use in a side panel for a mattress.

While the present invention has been illustrated and generally described above and will hereinafter be described in conjunction with certain potentially preferred embodiments, procedures, and practices, it is to be understood that in no case is the invention to be limited to such illustrated and described embodiments, procedures, and practices. On the contrary, it is intended that the present invention shall extend to all alternatives, modifications, and equivalents as may embrace the principles of the present invention within the true scope and spirit thereof.

### DESCRIPTION OF PREFERRED EMBODIMENTS

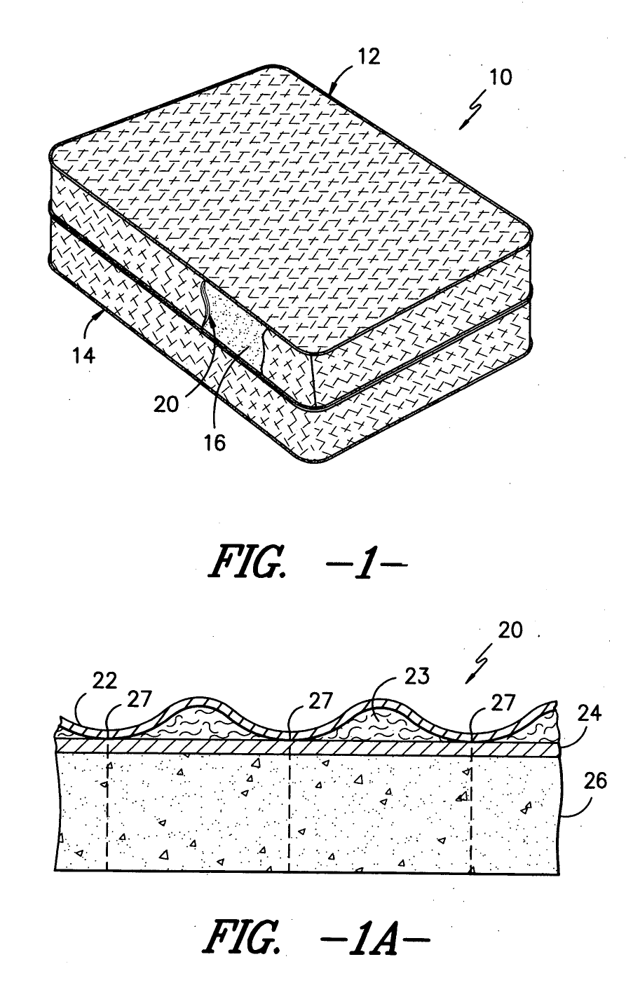

Reference will now be made to the various drawings wherein to the extent possible like reference numerals are utilized to designate corresponding components throughout the various views. In FIG. 1 there is illustrated a mattress and box spring set 10, including a mattress 12 and an underlying supporting box spring 14. As will be appreciated, the mattress 12 generally includes a core 16 of springs (not shown) surrounded by foam. If desired, the surrounding foam may be treated with an intumescent composition as will be described further hereinafter.

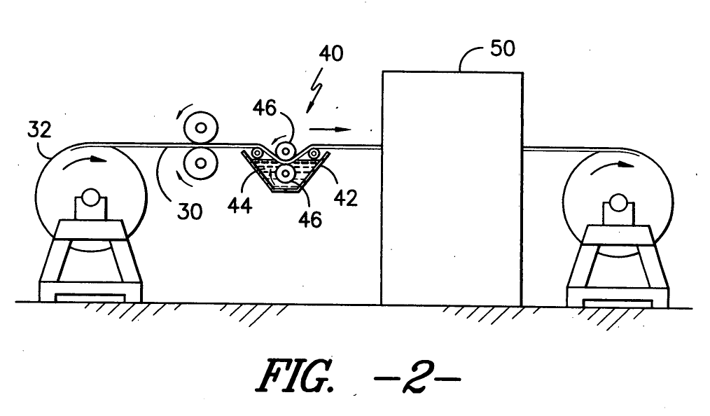

In the illustrated arrangement the core 16 is covered across a side surface by a side panel 20 that typically includes at least one layer of solid phase foam material 26 (FIG. 2). By way of example only, and not limitation, it is contemplated that such foam material 26 may include mechanically frothed or chemically blown foams of polyurethane, polystyrene or the like treated with an intumescent flame retardant composition as will be described more fully hereinafter. Similar side panel material may be disposed across side surfaces of the box spring 14. As will be appreciated, by the term “side surface” is meant a surface disposed along lateral sides and ends of the mattress and/or box spring that are normally in a substantially vertical orientation during use. It is contemplated that the intumescent flame retardant composition may be coated or infused at effective levels across one or both sides of at least one layer of foam material within the side panel 20 so as to provide substantial flammability resistance. The flame retardant composition may be applied in either a continuous or patterned manner although a continuous infused application may be preferred. Of course, it is contemplated that the side panel 20 may also include other constituents in a layered arrangement including one or more layers of fibrous textiles.

By way of example only, and not limitation one structure of a side panel 20 of multi-layer quilted construction is illustrated in FIG. 1A. As will be appreciated, for purposes of description various components are illustrated with enhanced dimensions and thus are not necessarily in scale relative to one another. As previously indicated, the side panel 20 may be disposed across one or more side surfaces of the mattress 12 and/or box spring 14. The illustrated exemplary side panel includes a surface fabric 22 such as a woven or knitted fabric defining the exterior side surface. A backing fabric 24 of woven, knit or nonwoven fabric is disposed in underlying relation to the surface fabric with the spaces between the surface fabric 22 and the backing fabric 24 filled by a high loft fibrous textile material 23. A layer of foam material 26 such as cellular polyurethane may be disposed below the textile layers to define a panel backing. In the illustrated construction a pattern of quilting yarns 27 extends through the various layers so as to provide a potentially desirable pattern of undulations across the outer surface. Of course, one or more intervening layers may be disposed above and/or below the foam material 26 if desired. By way of example only, and not limitation, such intervening layers or spacers may include woven or nonwoven fibrous textiles and the like. Of course, it is also contemplated that one or more layers of adhesive may be disposed at intersections between layers thereby eliminating or reducing any need for quilting yarns.

It is to be understood that the present invention is in no way limited to a particular construction of the side panel 20. By way of example only, it is contemplated that the backing fabric 24 or high loft fiber 23 may be eliminated or placed in different orders relative to one another. Likewise, additional layers may be inserted as desired including adhesive layers as previously indicated. In the event that quilting is eliminated the side panel 20 may have a substantially flat surface profile rather than the undulating surface profile illustrated.

Regardless of the actual construction used, the side panel will include at least one discrete or composite foam layer treated with an intumescent flame retardant composition. It is contemplated that the intumescent flame retardant composition may be coated or infused at effective levels across one or both sides so as to provide substantial flammability resistance.

The layer or layers of foam material treated with an intumescent flame retardant composition are preferably disposed near the outer surface of the side panel structure so as to provide early interference with flame propagation from burning bed clothes and the like. Thus, a treated layer of foam material 26 disposed in the relative position illustrated in FIG. 1A may be particularly desirable for some constructions.

One exemplary arrangement for infusing an intumescent flame retardant composition into a foam substrate is illustrated in FIG. 2. As shown, according to this practice a substrate material 30 such as a pre-cast urethane foam is conveyed from a roll 32 or other supply source to a treatment application station 40. By way of example only, and not limitation, in the illustrated practice the treatment application station includes a deposit reservoir 42 holding a fluid flame retardant composition 44 of intumescent character as will be described more fully hereinafter. Within the deposit reservoir a pair of cooperating nip rolls 46 compresses the substrate material below the fluid line of the flame retardant composition thereby driving flame retardant composition into the interior of the substrate. The infused deposit weight is preferably in the range of about 2.0 oz./yard² to about 20.0 oz./yard² (more preferably about 3.0 oz./yard² to about 15.0 oz./yard²) after drying and curing. Of course, it is to be understood that any number of other application processes as may be known to those of skill in the art including direct roll coaters, reverse roller coaters, spray coaters, knife coaters, saturation coaters, rotary screen coaters, curtain coaters, manifold deposit coaters and the like may likewise be utilized if desired. The substrate 30 with the applied flame retardant composition 44 may thereafter be passed through an oven 50 to cure the infused composition.

It will be understood that the viscosity of the flame retardant composition 44 will greatly affect the degree of infusion. By way of example only, for compositions incorporating a latex binder it is contemplated that viscosities greater than about 3000 (preferably about 3,000 to about 5,000) centipoise will tend to form a relatively stable discrete surface layer across the substrate 30 with a minor degree of infusion. Viscosities of less than about 2000 (preferably about 1,000 to about 2,000) centipoise will tend to migrate into a porous foam substrate by applied force, saturation, and/or capillary action to form an infused deposit extending into the substrate at a depth below the initial contact surface with only a light film remaining at the contact surface. Viscosities between about 2,000 and 3,000 centipoise will give rise to an intermediate level of infusion. Viscosities up to 20,000 centipoise or even greater may be desirable for certain specific applications.

According to one potentially preferred practice the coated or infused deposit of flame retardant composition 144 is of a composition of so called “intumescent” character such that it undergoes a swelling and charring when exposed to a flame in a manner as will be described further hereinafter. By way of example only, and not limitation, the flame retardant composition forming the coated or infused deposit preferably includes a polymer binder such as a latex acrylic co-polymer emulsion and a flame retardant composition intermixed with the polymer binder as well as dispersants and/or thickeners as desired to achieve desired physical characteristics to promote coating.

The potentially preferred intumescent compositions for use in the coated or infused deposit according to the present invention preferably incorporate the following basic constituents: (i) a phosphorous-releasing catalyst: (ii) a carbon donor: (iii) a blowing agent: and (iv) a halogen donor in the form of a liquid phase oil. It is contemplated that the composition may also include various binders, dispersants and thickeners as may be desired to promote processing and application.

As will be appreciated, it is contemplated that the actual constituents may be selected from a relatively wide range of alternatives. In this regard, exemplarily contemplated phosphorous-releasing catalysts may include mono-ammonium polyphosphate, diammonium polyphosphate, phosophated alcohols, phosophated glycols, potassium tripolyphosphate or combinations thereof. In the event that the treated article is to be subjected to laundering, the phosphorous-releasing catalyst will preferably be substantially insoluble in water thereby reducing degradation effects from cleaning. In this regard, mono-ammonium polyphosphate may be particularly preferred for such applications.

In the potentially preferred embodiments of the present invention, the carbon source is preferably pentaerythritol, dipentaerythritol (DPE), or a combination thereof. Such materials give rise to bridging between voids formed by gas evolution during the flame-activated intumescent reaction.

The blowing agent is preferably melamine, urea, dicyandiamide or combinations thereof. However, virtually any other suitable blowing agent may likewise be used.

As previously indicated, according to one potentially preferred practice, the halogen donor in the intumescent compositions of the present invention is preferably in the form of liquid halogenated oil. Such materials are preferably present at levels in the range of about 3 to about 20 percent by weight of the finished composition. Potentially desirable halogenated oils are characterized by exhibiting a liquid phase consistency with a viscosity of not greater than about 30,000 centipoise at room temperature (72 degrees F.). Chlorinated paraffin oils may be particularly preferred. However, for some applications brominated, fluorinated or other halogenated oils may also be utilized alone or in combination with one another and/or in combination with chlorinated oils if desired. It is believed that the halogenated oils act as a plasticizer within a latex or other binder thereby softening the final composition after application to or infusion into an article to be protected. Thus, the final article is not stiffened to an excessive degree. The invention may be further understood through reference to the following non-limiting example.

### EXAMPLE

A low viscosity flame retardant composition characterized by a room temperature viscosity of about 1,000 to about 2,000 centipoise was produced utilizing the formulation as set forth in Table 1.

TABLE 1

| ITEM | PERCENT (%) |
|---|---|
| PREMIX | |
| Water | 28.877 |
| Naphthalene Sulfonate | 0.8 |
| Polyoxyethylene Tridecyl Alcohol | 0.72 |
| Ammonium Casein | 4.28 |
| Surfactant | 1.4 |
| Melamine | 8.1 |
| Mono-Ammonium Polyphoshate | 20.21 |
| Pentaerythritol | 8.1 |
| Zinc Borate | 5.69 |
| Antimony Oxide | 5.21 |
| Urea | 0.8 |
| Sulfonated 2 Ethyl Hexanol, 60% | 0.27 |
| Triethanolamine | 0.68 |
| Aluminum Trihydrate | 12.19 |
| Karaya Gum Solution, 5% | 2.67 |
| TOTAL | 100 |
| FINISHED FORMULA | |
| Premix from above | 70.55 |
| Chlorinated Paraffin Oil | 9.2 |
| Acrylic Latex | 19.95 |
| Aqua Ammonia | 0.3 |
| TOTAL | 100 |

According to the practice utilized, the constituents forming a premix were blended in an attritor to effect both blending and particle size reduction until all solids were below about 150 microns. As will be appreciated, the premix contained a carbon donor in the form of pentaerythritol as well as a blowing agent in the form of melamine in combination with urea. Various constituents were also added to aid in processing and to enhance the suitability for substrate application. In particular, naphthalene sulfonate was added as a dispersant. It is also contemplated that the dispersant may be modified by use of materials such as lignin sulfonate, sulfonated naphthalene condensate or combinations thereof. Polyoxyethylene tridecyl alcohol with 6 mole equivalents of ethoxilation was added as a wetting agent. Ammonium Casein was added as a thickener to enhance body and retain solid additives in suspension so as to promote enhanced shelf life. The surfactant utilized was supplied by Air Products Corporation under the trade designation Surfynol CT-131. Zinc Borate and Antimony Oxide were added to enhance resistance to post-combustion after glow and to enhance resistance to vertical burning respectively. While such additions may be desirable for some environments of use, it is to be understood that their addition is discretionary. Sulfonated 2 Ethyl Hexanol was added to aid in fluidity. Triethanolamine is a base used to control pH and to aid in stability. The Aluminum Trihydrate is believed to reduce surface tack while also promoting flame resistance by releasing water when subjected to heat. Finally, The Karaya Gum Solution was added as a thickener. Of course, it is to be understood that the actual additives and amounts may be subject to a wide range of variations depending upon the desired character and processing conditions.

Following formation of the premix in the attritor the premix was thereafter intermixed with a latex carrier or binder. One potentially preferred latex base is a low T_{g} acrylic latex available from Adhesive Coatings Technologies in Dalton, Ga. under the trade designation BSD 315. It is also contemplated that other binder materials such as vinyl acetate-ethylene copolymers and the like may be utilized if desired. A halogen donating chlorinated paraffin oil was added during the mixing process. By way of example only, and not limitation, one such chlorinated paraffin oil which is believed to be particularly suitable is marketed under the trade designation KLORO 6001-emulsion by Dover Chemical Corporation. Finally, in order to achieve the desired viscosity, aqua ammonia was added to raise the pH to above about 8.0. The resultant composition was characterized by a viscosity in the range of about 1,000 to about 2,000 centipoise and was suitable for application to substrates using surface deposition and forced infusion as described above such that the intumescent composition extends in infused relation at least a predefined depth into the substrate.

The resultant composition was applied to a pre-cast urethane foam of approximately 0.500 inches in thickness, having a density of about 1.2 pounds per cubic foot at a coating weight of about 10.0 ounces per square yard using a reverse roller coater. The coating composition permeated a substantial distance below the surface of the foam so as to saturate the foam. The coated foam was then dried at a temperature of about 300° F. to cure the binder. The infused foam retained substantial pliability and resiliency.

For purposes of comparison samples of the infused foam and the same foam with no coating were subjected to flame tests in which the samples were, while in a horizontal position, exposed to a large open flame presented by a horizontal propane-fueled burner with multiple orifices, simulating the NIST burner apparatus utilized in the large-scale test of Technical Bulletin 603. The time of exposure was 70 seconds, the same as specified for the top burner portion of the Technical Bulletin 603 tests. The infused foam retained substantial pliability and resiliency. The infused foam did not burn while the untreated foam exhibited substantial combustion.

While the present invention has been illustrated and described in relation to certain potentially preferred embodiments and practices, it is to be understood that such embodiments and practices are illustrative and exemplary only and that the present invention is in no event to be limited thereto. Rather, it is contemplated that modifications and variations to the present invention will no doubt occur to those of skill in the art upon reading the above description and/or through a practice of the invention. It is therefore contemplated and intended that the present invention shall extend to all such modifications and variations that incorporate the broad principles of the present invention within the full spirit and scope thereof.

1. A mattress comprising a mattress panel structure adapted for covering a mattress core to define a mattress side surface, the mattress panel structure comprising: at least one pliable cellular foam layer having a flame retardant composition of intumescent character disposed in coated or infused relation across said at least one cellular foam layer to increase flammability resistance of said at least one cellular foam layer, wherein the flame retardant composition is substantially free of bromine and comprises a blend comprising: a phosphorous releasing catalyst; a carbon donor; a blowing agent; and a halogen donor comprising a halogenated paraffin oil within a latex base.

2. The invention as recited in claim 1, wherein the phosphorous releasing catalyst is substantially insoluble in water.

3. The invention as recited in claim 2, wherein the phosphorous releasing catalyst is mono-ammonium polyphosphate.

4. The invention as recited in claim 1, wherein the carbon donor is selected from the group consisting of pentaerythritol, dipentaerythritol and combinations thereof.

5. The invention as recited in claim 1, wherein the blowing agent is selected from the group consisting of melamine, urea, dicyandiamide and combinations thereof.

6. The invention as recited in claim 1, wherein the latex base comprises an acrylic latex.

7. The invention as recited in claim 1, wherein the phosphorous releasing catalyst is mono-ammonium polyphosphate, wherein the carbon donor is selected from the group consisting of pentaerythritol, dipentaerythritol and combinations thereof, and wherein the blowing agent is selected from the group consisting of melamine, urea, dicyandiamide and combinations thereof.

8. The invention as recited in claim 1, wherein the flame retardant composition is characterized by a viscosity of 1,000 to 2,000 centipoise.

9. The invention as recited in claim 1, wherein the halogen donor comprises a chlorinated paraffin oil present at a level in the range of 3 to 20 percent by weight of the flame retardant composition and wherein the chlorinated paraffin oil is characterized by being in a liquid phase and having a viscosity of not greater than 30,000 centipoise at room temperature.

10. A mattress comprising a mattress panel structure adapted for covering a mattress core to define a mattress side surface, the mattress panel structure comprising: at least one pliable cellular foam layer having a flame retardant composition of intumescent character disposed in coated or infused relation across said at least one cellular foam layer to increase flammability resistance of said at least one cellular foam layer, wherein the flame retardant composition is substantially free of bromine and comprises a blend comprising: at least one of the group consisting of zinc borate and antimony oxide in combination with a phosphorous releasing catalyst; a carbon donor; a blowing agent; and a halogen donor in the form of a chlorinated paraffin oil blended within a latex base, wherein the chlorinated paraffin oil is present at a level in the range of 3 to 20 percent by weight of the flame retardant composition, and wherein the chlorinated paraffin oil is characterized by being in a liquid phase and having a viscosity of not greater than 30,000 centipoise at room temperature.

11. The invention as recited in claim 10, wherein the flame retardant composition of intumescent character further comprises Aluminum Trihydrate.

12. The invention as recited in claim 10 wherein the phosphorous releasing catalyst is substantially insoluble in water.

13. The invention as recited in claim 12, wherein the phosphorous releasing catalyst is mono-ammonium polyphosphate.

14. The invention as recited in claim 10, wherein the carbon donor is selected from the group consisting of pentaerythritol, dipentaerythritol and combinations thereof.

15. The invention as recited in claim 10, wherein the blowing agent is selected from the group consisting of melamine, urea, dicyandiamide and combinations thereof.

16. The invention as recited in claim 10, wherein the flame retardant composition is characterized by a viscosity of 3,000 to 5,000 centipoise.

17. A mattress comprising a mattress panel structure adapted for covering a mattress core to define a mattress side surface, the mattress panel structure comprising: a surface fabric defining an outwardly projecting exterior; at least one backing fabric layer disposed at a position below the surface fabric and at least one layer of foam disposed at a position below said at least one backing fabric layer, wherein said at least one layer of foam comprises a pliable cellular foam layer having a flame retardant composition of intumescent character disposed in infused relation across said cellular foam layer to increase flammability resistance of said foam layer, wherein the flame retardant composition is substantially free of bromine and comprises a blend comprising: a phosphorous releasing catalyst; a carbon donor; a blowing agent; and a halogen donor within a latex base, wherein the halogen donor comprises a chlorinated paraffin oil present at a level in the range of 3 to 20 percent by weight of the flame retardant composition and wherein the chlorinated paraffin oil is characterized by being in a liquid phase and having a viscosity of not greater than 30,000 centipoise at room temperature.

18. The invention as recited in claim 17, wherein the cellular foam layer is polyurethane.
